(19) United States
(12) Patent Application Publication
(10) Pub. No.: US 2016/0245842 A1
(43) Pub. Date: Aug. 25, 2016

(54) MEASUREMENT APPARATUS, MEASUREMENT METHOD, AND MEASUREMENT SYSTEM

(71) Applicant: Seiko Epson Corporation, Tokyo (JP)

(72) Inventors: Yasushi YOSHIKAWA, Chino (JP); Yoshihiro KOBAYASHI, Komagane (JP)

(21) Appl. No.: 15/048,406

(22) Filed: Feb. 19, 2016

(30) Foreign Application Priority Data
Feb. 20, 2015 (JP) 2015-031760

(51) Int. Cl. G01P 15/18

(52) U.S. Cl. CPC G01P 15/18

(57) ABSTRACT

A measurement apparatus includes an acceleration sensor that detects values of acceleration in a plurality of directions; a calculation unit that calculates a predetermined physical quantity based on the values of the acceleration in the plurality of directions; an output unit that outputs data; and a selection unit that selects data to be output from the output unit, from among the values of the acceleration in the plurality of directions and the predetermined physical quantity.

### BACKGROUND

1. Technical Field

The present invention relates to a measurement apparatus, a measurement method, and a measurement system.

2. Related Art

JP-A-2013-250236 discloses an inclination angle calculation apparatus including an acceleration acquisition unit that acquires vertical acceleration of a moving object in a vertical direction relative to the ground; an inclination angle calculation unit that calculates an inclination angle of the ground, based on the vertical acceleration acquired by the acceleration acquisition unit and predetermined gravity acceleration; a determination unit that determines the vertical movement of the moving object, based on movement history of the moving object and altitude data indicating the altitude of each location of the moving object, and an output unit that associates a determination result of the determination unit and the inclination angle, and outputs the associated result and angle.

However, the type to be used among various types of data obtained by a single measurement apparatus may vary depending on a user or an application.

For example, it is assumed that the measurement apparatus can measure nine types of data: three values of acceleration in x, y, and z-axis directions, three inclination angles of x, y, and z axes, and the three inclination angular velocities around the x, y, and z axes. A certain user may use, for example, three types of data: two inclination angles of the x and y axes and the acceleration in the z-axis direction, among these nine types of data. Further, another user may use, for example, three types of data: the inclination angles of the x and z axes and the acceleration in the y-axis direction. Similarly, the types of data to be used may be different, depending on applications employing the measurement apparatus 1.

It is conceivable to output all types of data from the measurement apparatus so as to support all different users or applications. For example, in the above example case, it is conceivable to provide nine output ports in the measurement apparatus, and output the nine types of data from the respective output ports. Further, it is also conceivable to sequentially output the nine types of data from a single output port.

However, there is a problem that the measurement apparatus provided with output ports corresponding to all types of data becomes large. Further, if all types of data are sequentially output from a single output port, there is a problem that data that is not necessary for users or applications is included in the output data, and the output data rate of the measurement apparatus is compressed due to the data.

Further, in JP-A-2013-250236, only an output of a determination result about the vertical movement of the moving object and the inclination angle is described, and the selection and output of the determination result about the vertical movement and the inclination angle depending on the user or the application is not described.

### SUMMARY

An advantage of some aspects of the invention is to provide a technique capable of suppressing the expansion of the apparatus scale or the compression of the data rate, and supporting various users or applications.

A first aspect of the invention is directed to a measurement apparatus including an acceleration sensor that detects values of acceleration in a plurality of directions; a calculation unit that calculates a predetermined physical quantity based on the values of the acceleration in the plurality of directions; an output unit that outputs data; and a selection unit that selects data to be output from the output unit, from among the values of the acceleration in the plurality of directions and the predetermined physical quantity. According to the first aspect, the measurement apparatus is capable of suppressing the expansion of the apparatus scale or the compression of the data rate, and supporting various users or applications.

In the measurement apparatus, the acceleration sensor may detect values of acceleration in three-axis directions which are in a mutually perpendicular relationship. With this configuration, the measurement apparatus is capable of selecting data from among the values of the acceleration in three-axis directions and the predetermined physical quantity, and outputting the data.

In the measurement apparatus, the calculation unit may calculate an inclination angle in a predetermined direction, as the predetermined physical quantity. With this configuration, the measurement apparatus is capable of selecting data from among a plurality of values of acceleration, the inclination angles in the plurality of directions, and a predetermined physical quantity, and outputting the data from the output unit.

In the measurement apparatus, the calculation unit may calculate an inclination angular velocity around each axis of axes in predetermined directions, as the predetermined physical quantity. With this configuration, the measurement apparatus is capable of selecting data from among a plurality of values of acceleration, inclination angular velocities around axes in plurality of directions, and a predetermined physical quantity, and outputting the data from the output unit.

In the measurement apparatus, the acceleration sensor may detect values of acceleration in three-axis directions which are in a mutually perpendicular relationship, the calculation unit may calculate inclination angles of three axes and inclination angular velocity around each axis of the three axes, based on the values of the acceleration in three-axis directions, as the predetermined physical quantities, and the selection unit may select three pieces of data to be output from the output unit, from among the values of the acceleration in three-axis directions, the inclination angles of three axes, and the inclination angular velocity around each axis of the three axes. With this configuration, the measurement apparatus is capable of selecting three pieces of data, from among the values of the acceleration in three-axis directions, the inclination angles of three axes, and the inclination angular velocity around each axis of the three axes, and outputting the data from the output unit.

The measurement apparatus may further include a reception unit that receives a command from the outside, and the selection unit may select data to be output from the output unit, in response to the command. With this configuration, the measurement apparatus is capable of outputting the data corresponding to the command from the output unit.

The measurement apparatus may further include a storage unit that stores the command so as to be readable from the outside. With this configuration, an external apparatus can read the command in the storage unit, and check or recognize the data to be output by the measurement apparatus.

In the measurement apparatus, the output unit may output the data selected by the selection unit, in a predetermined order. With this configuration, the measurement apparatus is capable of outputting the data from a single output unit, while suppressing the compression of a data rate.

The measurement apparatus may further include a decimation unit that performs a decimation process on at least one of the values of the acceleration in the plurality of directions and the data selected by the selection unit; and a reception unit that receives a command from the outside, and the decimation unit may perform the decimation process, in response to the command. With this configuration, the measurement apparatus is capable of performing the decimation process on at least one of the acceleration and the data selected by the selection unit, in response to the command from the outside, and changing the output rate of data to be output.

In the measurement apparatus, when the command is an instruction on an output at a cycle of a predetermined cycle or more corresponding to an available memory capacity, the decimation unit may average decimation values at the predetermined cycle, at a cycle that is instructed by the command. With this configuration, even if the command from the outside is an instruction on an output at a cycle of a predetermined cycle or more corresponding to an available memory capacity, the measurement apparatus is capable of performing the decimation process on at least one of the acceleration and the data selected by the selection unit.

A second aspect of the invention is directed to a measurement method including detecting values of acceleration in a plurality of directions; calculating a predetermined physical quantity, based on the values of the acceleration in a plurality of directions; and selecting data to be output from an output unit, from among the values of the acceleration in the plurality of directions and the predetermined physical quantity. According to the second aspect, the measurement apparatus is capable of suppressing the expansion of the apparatus scale or the compression of the data rate, and supporting various users or applications.

A third aspect of the invention is directed to a measurement system including a controller that outputs a command; and a measurement apparatus including a reception unit that receives the command; an acceleration sensor that detects values of acceleration in a plurality of directions; a calculation unit that calculates a predetermined physical quantity, based on the values of the acceleration in the plurality of directions; an output unit that outputs data; a selection unit that selects data to be output from an output unit, from among the values of the acceleration in the plurality of directions and the predetermined physical quantity, in response to the command. According to the third aspect, the measurement system is capable of suppressing the expansion of the apparatus scale or the compression of the data rate, and supporting various users or applications.

### BRIEF DESCRIPTION OF THE DRAWINGS

The invention will be described with reference to the accompanying drawings, wherein like numbers reference like elements.

FIG. 1 is a diagram illustrating a configuration example of a measurement system according to a first embodiment.

FIG. 2 is a diagram illustrating a block configuration example of a measurement apparatus.

FIG. 3 is a diagram illustrating a calculation example of an inclination angle.

FIG. 4 is a diagram illustrating a calculation example of an inclination angular velocity.

FIG. 5 is a diagram illustrating an example of commands.

FIG. 6 is a diagram illustrating an example of a command that is stored in a storage unit.

FIG. 7 is a diagram illustrating a block configuration example of a measurement apparatus according to a second embodiment.

FIG. 8 is a diagram illustrating a block configuration example of a measurement apparatus according to a third embodiment.

FIG. 9 is a diagram illustrating another block configuration example of the measurement apparatus.

### DESCRIPTION OF EXEMPLARY EMBODIMENTS

Hereinafter, embodiments of the invention will be described with reference to the drawings.

### First Embodiment

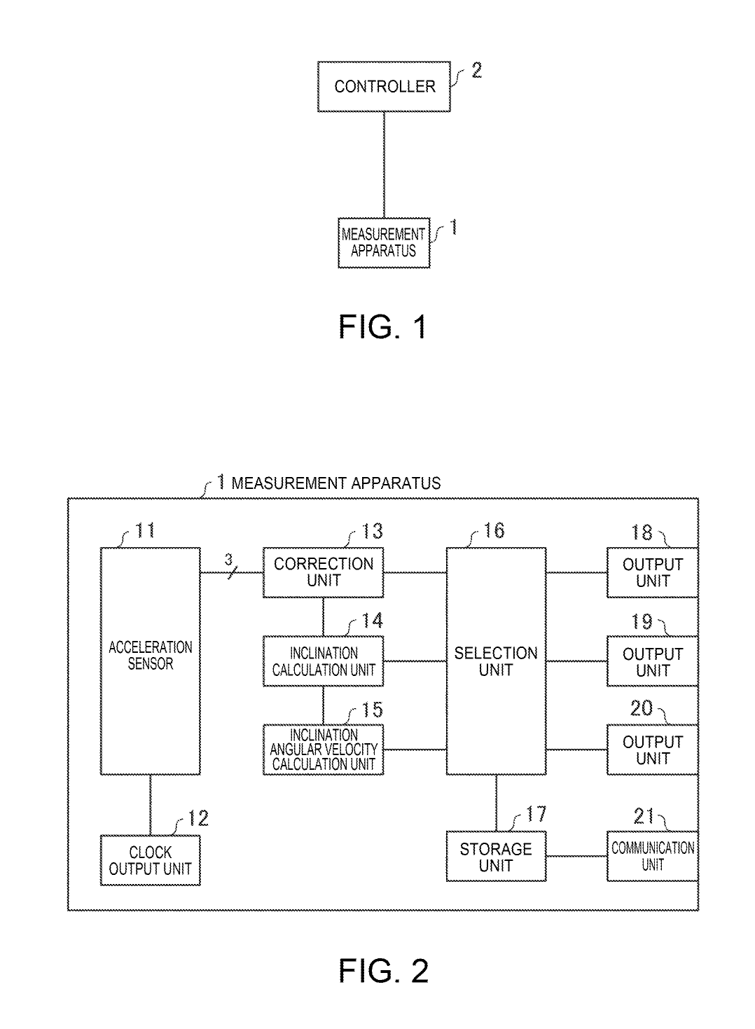

FIG. 1 is a diagram illustrating a configuration example of a measurement system according to a first embodiment. As illustrated in FIG. 1, the measurement system includes a measurement apparatus 1, and a controller 2.

A measurement apparatus 1 can measure nine types of data: the values of the acceleration in x, y, and z-axis directions which are in a mutually perpendicular relationship, the inclination angles of x, y, and z axes (angles between the x, y, and z axes and a horizontal plane), and the inclination angular velocities around the respective x, y, and z axes. The measurement apparatus 1 is provided with, for example, three output units (for example, output ports), selects three types of data among nine types of measurable data, and outputs respectively the selected data pieces from the three output units to the controller 2. Hereinafter, a description will be made, with the x, y, and z directions as directions indicated in a right-handed coordinate system.

The measurement apparatus 1 is attached to, for example, an object to be measured, such as a ship. A method for attaching the measurement apparatus 1 to the object to be measured is different, depending on the user or the application.

For example, there is a case where the measurement apparatus 1 is attached in such a manner that an x-axis is directed to the bow direction of a ship, a y-axis is directed to the portside direction of the ship, and a z-axis is directed to the vertical direction of the floor, on the floor near the center of gravity of the ship (hereinafter, referred to as “a first attachment method”). Alternatively, there is a case in which the measurement apparatus 1 is attached in such a manner that, for example, the x-axis is directed to the portside direction of the ship, the y-axis is directed to the direction parallel to the vertical wall, and the z-axis is directed to the bow direction of the ship, on the vertical wall near the center of gravity of the ship, of which a normal is directed to the bow direction (hereinafter, referred to as “a second attachment method”).

The controller 2 is connected to the measurement apparatus 1 in a wired or wireless manner. The controller 2 instructs the measurement apparatus 1 to output the type of data, in response to the operation of the user.

For example, it is assumed that the controller 2 instructs the measurement apparatus 1 to output the inclination angle of the x-axis, the inclination angle of the y-axis, and the acceleration of the z-axis, in response to the operation of the user. In this case, the measurement apparatus 1 selects the inclination angle of the x-axis, the inclination angle of the y-axis, and the acceleration of the z-axis, from the measurable nine types of data, and outputs the selected data pieces from three output units to the controller 2. For example, it is assumed that the controller 2 instructs the measurement apparatus 1 to output the inclination angle of the x-axis, the inclination angle of the z-axis, and the acceleration of the y-axis, in response to the operation of the user. In this case, the measurement apparatus 1 selects the inclination angle of the x-axis, the inclination angle of the z-axis, and the acceleration of the y-axis, from the measurable nine types of data, and outputs the selected data pieces from three output units to the controller 2.

In this manner, the measurement apparatus 1 is provided with three output units, selects three types of data that are designated by the controller 2, among nine types of data, and outputs the three types of data from the three output units. Thus, the measurement apparatus 1 is able to support various users or applications, using three output units, of a number less than the number of nine types of data.

For example, it is assumed that the user calculates the inclination of the floor of the ship, from the inclination angles of two axes relative to the horizontal plane, and determines whether or not the floor of the ship is stationary (is not shaking), based on the acceleration of one axis.

In this case, a certain user may attach the measurement apparatus 1 to the floor of the ship, by the first attachment method. Then, the certain user may desire to output the inclination angles of the x and y axes and the acceleration in the z-axis direction from the measurement apparatus 1 to the controller 2, cause the controller 2 to calculate the inclination of the floor of the ship, from the inclination angles of the x and y axes, and determine whether the floor stops moving, from the acceleration in the z-axis direction.

Further, another user may attach the measurement apparatus 1 to the vertical wall surface of the ship, by the second attachment method. Then, another user may want to output the inclination angles of the x and z axes and the acceleration in the y-axis direction, from the measurement apparatus 1 to the controller 2, cause the controller 2 to calculate the inclination of the floor of the ship, determine the stop of the floor, from the inclination angles of the x and z axes, and from the acceleration in the y-axis direction.

As described above, if the attachment method for the measurement apparatus 1 is different, the assignment of each axis direction in the measurement apparatus 1, in other words, the direction of the axis corresponding to the object to be measured is different, such that the types of data to be output from three output units of the measurement apparatus 1 are different. However, the user is able to designate the types of data to be output from the measurement apparatus 1, using the controller 2. For example, the certain user is able to output the inclination angles of the x and y axes and the acceleration in the z-axis direction, from the three output units of the measurement apparatus 1, by using the controller 2. Another user is able to output the inclination angles of the x and z axes and the acceleration in the y-axis direction, from the three output units of the measurement apparatus 1, by using the controller 2. In this manner, the measurement apparatus 1 is able to support various users or applications, using three output units, of a number less than the number of nine types of data.

The output destination of data of the measurement apparatus 1 is the controller 2 in the above description, but may be another device other than the controller 2. For example, another device other than the controller 2 may receive the data that is output from the measurement apparatus 1, and calculate the inclination or the like of the floor of the ship.

When outputting the data to another device, the measurement apparatus 1 may not always be connected with the controller 2. For example, when the user wants to change the type of data to be output by the measurement apparatus 1, the user may connect the controller 2 to the measurement apparatus 1 so as to change the type of data to be output by the measurement apparatus 1.

Further, the measurement apparatus 1 is provided with three output units in the above description, but the number is not limited thereto. For example, the measurement apparatus 1 may be provided with a smaller number of output units than the number of types of data that can be measured (in the case of the above example, nine).

The example of the object to be measured is a ship in the above description, but the object to be measured may be an elevator or the like. For example, it is possible to install the measurement apparatus 1 on the floor or the wall of the elevator, and measure the inclination of the floor and a stationary state of the elevator.

FIG. 2 is a diagram illustrating exemplary functional blocks of the measurement apparatus 1. As illustrated in FIG. 2, the measurement apparatus 1 includes an acceleration sensor 11, a clock output unit 12, a correction unit 13, an inclination calculation unit 14, an inclination angular velocity calculation unit 15, a selection unit 16, a storage unit 17, output units 18 to 20, and a communication unit 21.

In the following, it is assumed that the measurement apparatus 1 is generally in a stationary state or a constant velocity linear motion state. That is because it is not possible to distinguish whether the acceleration output from the acceleration sensor 11 is the acceleration due to the gravity acceleration or the acceleration due to the acceleration motion, when the measurement apparatus 1 is in the acceleration motion state.

The acceleration sensor 11 detects values of the acceleration (gravity acceleration) in x, y, and z-axis directions which are in a mutually perpendicular relationship. The x and y axes of the acceleration sensor 11 are, for example, in a mounting surface of the housing of the measurement apparatus 1 (in a plane in which the measurement apparatus 1 is attached to an object to be measured), and the z axis is in the vertical direction relative to the mounting surface of the measurement apparatus 1.

The acceleration sensor 11 is provided with, for example, vibrators on the x, y, and z axes, and measures the change in the oscillation frequency based on the vibrator on each axis, using a clock output from the clock output unit 12. The oscillation frequency of each axis varies depending on the acceleration of the vibrator on each axis, and the acceleration sensor 11 detects the acceleration in each axis direction, from the change in the oscillation frequency of each axis. The acceleration sensor 11 outputs acceleration in each axis direction that is detected, to the correction unit 13 with a predetermined output rate.

In addition, the detection of the acceleration of the acceleration sensor 11 is not limited to the above method. For example, the acceleration sensor 11 may convert the change in the capacitance caused by a micro electro mechanical system (MEMS) into a voltage, and detect the acceleration.

The clock output unit 12 outputs the clock of a constant frequency to the acceleration sensor 11.

The correction unit 13 corrects the values of the acceleration in the x, y, and z-axis directions which is output from the acceleration sensor 11. For example, the correction unit 13 performs the alignment correction, the offset correction, the temperature drift correction and the like of the values of the acceleration in the x, y, and z-axis directions which are output from the acceleration sensor 11. Incidentally, when the alignment, the offset, the temperature drift and the like of the acceleration which is output from the acceleration sensor 11 is small, the correction unit 13 may omit the correction.

The inclination calculation unit 14 (which corresponds to the calculation unit according to the invention) calculates the inclination of each axis relative to the horizontal plane, based on the values of the acceleration in the x, y, z-axis directions which are corrected by the correction unit 13.

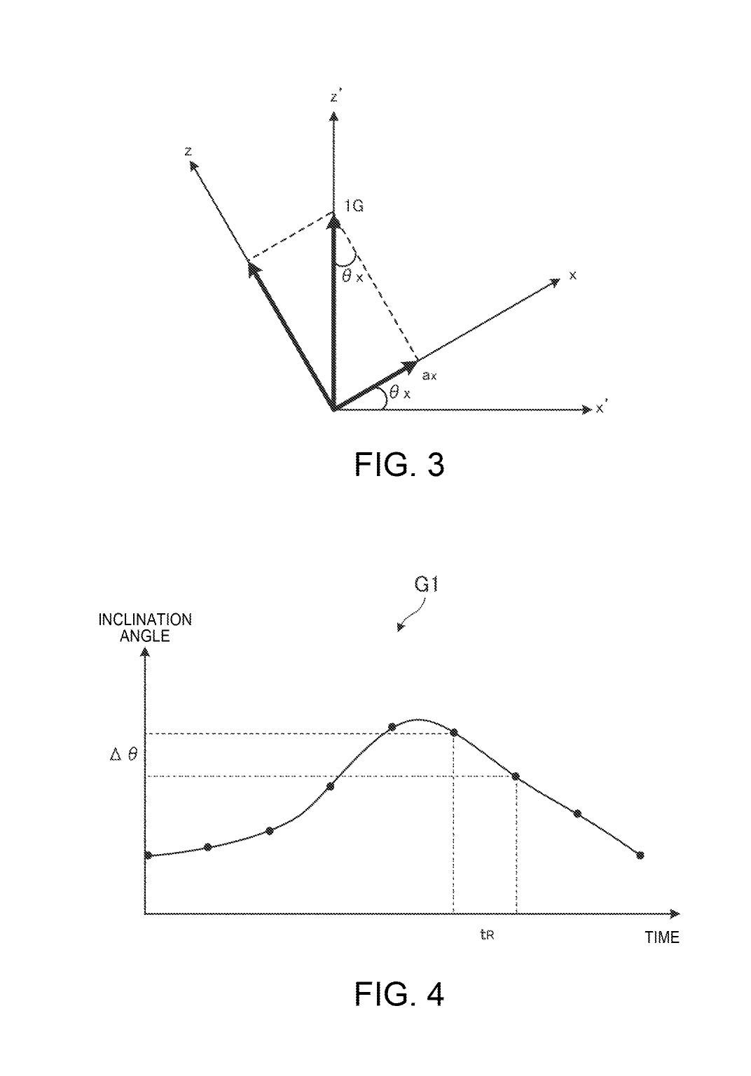

FIG. 3 is a diagram illustrating a calculation example of an inclination angle. “x′” illustrated in FIG. 3 represents an axis parallel to the horizontal direction. “z′” represents an axis parallel to the gravity direction. “x” represents the x axis of the acceleration sensor 11. “z” represents the z axis of the acceleration sensor 11. In addition, it is assumed that the “y” axis of the acceleration sensor 11 is directed to the back surface direction of the paper. In addition, it is assumed that the orientation of the gravity acceleration is an upward direction in FIG. 3.

It is assumed that the x axis of the acceleration sensor 11 is inclined by the angle “θₓ”, with the y-axis as a rotation angle, as illustrated in FIG. 3.

In this case, if the acceleration (gravity acceleration component) in the x-axis direction, which is output from the acceleration sensor 11 is “aₓ”, the following Expression (1) is established.

$$sin {θ}_{x} = \frac{{a}_{x}}{1 G} \qquad ( 1 )$$

“1G” in Expression (1) is the gravity acceleration, and “1G=9.80665 m/s²”.

By Expression (1), the inclination “θₓ” for the horizontal direction of the x-axis is represented by the following Expression (2).

$${θ}_{x} = {sin}^{- 1} \frac{{a}_{x}}{1 G} \qquad ( 2 )$$

In the same manner, the inclinations “θ_{y}” and “θ_{z}” of the y and z axes for the horizontal direction are represented by the following Expression (3) and Expression (4).

$$\begin{matrix}{θ}_{y} = {sin}^{- 1} \frac{{a}_{y}}{1 G} & ( 3 ) \\ {θ}_{z} = {sin}^{- 1} \frac{{a}_{z}}{1 G} & ( 4 )\end{matrix}$$

“a_{y}” in Expression (3) is the acceleration in the y-axis direction, and “a_{z}” in Expression (4) is the acceleration in the z-axis direction.

In other words, the inclination calculation unit 14 calculates the inclination angles of the x, y, and z axes for the horizontal direction, by performing the calculations represented in Expression (2) to Expression (4), based on the accelerations “aₓ”, “a_{y}”, and “a,” in the x, y, and z-axis directions, which are output from the correction unit 13, and the gravity acceleration “1G”.

In addition, the inclination calculation unit 14 may calculate the inclination angle of each axis, using the gravity acceleration (1G) which is previously set (stored) in the measurement apparatus 1. In this case, the latitude in which the measurement apparatus 1 is used may be considered for the value of the gravity acceleration that is set in the measurement apparatus 1.

Further, the inclination calculation unit 14 may calculate the gravity acceleration, from the acceleration that is output from the correction unit 13. For example, the inclination calculation unit 14 calculates the gravity acceleration using “(aₓ²+a_{y}²+a_{z}²)^{1/2}”.

Here, the output range of the inclination of the x axis “θₓ”, which is calculated by the inclination calculation unit 14, will be described. As described above, since the measurement apparatus 1 is in a generally stationary state, or a constant velocity linear motion state, the acceleration in the x-axis direction only has the component of the gravity acceleration. Therefore, the range of the acceleration in the x-axis direction is represented by the following Expression (5).

−9.80665 m/s²≦aₓ≦9.80665 m/s² (5)

If dividing Expression (5) by “1G”, Expression (6) is obtained.

$$- 1 \leq \frac{{a}_{x}}{1 G} \leq + 1 \qquad ( 6 )$$

From Expression (6), the available range of the angle “θₓ” is “+90 degrees” in a clockwise direction, and “−90 degrees” in a counterclockwise direction in FIG. 3, with the angle when the x axis is the horizontal direction as “0 degrees”. Therefore, the inclination calculation unit 14 can achieve the inclination “θₓ” of the x axis in the range of “−90 degrees to 90 degrees”, with the horizontal direction as “0 degrees”. In other words, the angle that is calculated from the acceleration value using the gravity acceleration is not a rotation angle, but rather an inclination angle relative to the horizontal plane. The same is applied to the inclination angle of the y and z axes.

Incidentally, when the inclination angles of the x, y, and z axes exceed the range of “−90 degrees to 90 degrees”, the inclination calculation unit 14 outputs again the inclination angles in the range of “−90 degrees to 90 degrees”, with the horizontal direction as “0 degrees”.

Further, as the inclination angle of each axis approaches “90 degrees” or “−90 degrees” (as the range of the sine function approaches “1”), the rate of change in the acceleration is reduced. Therefore, it is difficult to distinguish the change in the inclination angle due to acceleration and the change in the inclination angle due to noise. In other words, as the inclination angle that is output from the inclination calculation unit 14 approaches “90 degrees” or “−90 degrees”, the influence of an error is increased. Therefore, the inclination calculation unit 14 may be configured to output the inclination angle of a predetermined range. For example, the inclination calculation unit 14 may be configured to output the inclination angle in the range of “−60 degrees to 60 degrees.”

The description about FIG. 2 will be given again. The inclination angular velocity calculation unit 15 (which corresponds to the calculation unit according to the invention) calculates the inclination angular velocities around the x, y, and z axes, based on the inclination angles of the x, y, and z axes, which are calculated by the inclination calculation unit 14.

FIG. 4 is a diagram illustrating a calculation example of an inclination angular velocity. The horizontal axis of the graph G1 in FIG. 4 represents time. The vertical axis represents the inclination angle that is output from the inclination calculation unit 14. In FIG. 4, in order to simplify the explanation, a description will be made without distinguishing the inclination angle of the x, y, and z axes which are output from the inclination calculation unit 14 on the x, y, and z axes.

“t_{R}” indicated in the graph G1 represents an output rate of the inclination angle that is output by the inclination calculation unit 14. The black circle in the graph G1 represents the inclination angle that is output by the inclination calculation unit 14 at the output rate “t_{R}”.

The inclination angle change “Δθ” indicated in the graph G1 represents the change in the inclination angle of the inclination calculation unit 14 with respect to the output rate “t_{R}”. The inclination angular velocity is the change in the inclination angle per unit time basis, and is represented by the following Expression (7).

$$\frac{d θ}{d t} = \frac{Δ θ}{{t}_{R}} \qquad ( 7 )$$

Accordingly, the inclination angular velocity calculation unit 15 can calculate the inclination angular velocities around the x, y, and z axes, from the change in the inclination angles of the x, y, and z axes, at the output rate “t_{R}” of the inclination calculation unit 14.

The inclination angular velocity around the x axis, the inclination angular velocity around the y axis, and the inclination angular velocity around the z axis are represented by the following Expression (8) to Expression (10), from Expression (7).

$$\begin{matrix}\frac{d {θ}_{y}}{d t} = \frac{Δ {θ}_{y}}{{t}_{R}} & ( 8 ) \\ \frac{d {θ}_{z}}{d t} = \frac{Δ {θ}_{z}}{{t}_{R}} & ( 9 ) \\ \frac{d {θ}_{x}}{d t} = \frac{Δ {θ}_{x}}{{t}_{R}} & ( 10 )\end{matrix}$$

“θ_{y}” in Expression (8) represents the inclination angle relative to the horizontal direction of the y axis of the acceleration sensor 11. “θ_{z}” in Expression (9) represents the inclination angle relative to the horizontal direction of the z axis of the acceleration sensor 11. “θₓ” in Expression (10) represents the inclination angle relative to the horizontal direction of the x axis of the acceleration sensor 11.

Incidentally, the inclination angular velocity around the x axis in Expression (8) is calculated from the amount of change per unit time in the inclination angle “θ_{y}”, but may be calculated from the amount of change per unit time in the inclination angle “θ_{z}”. Further, the inclination angular velocity around the y axis in Expression (9) may be calculated from the amount of change per unit time in the inclination angle “θ_{z}”, and may be calculated from the amount of change per unit time in the inclination angle “θₓ”. Further, the inclination angular velocity around the z axis in Expression (10) may be calculated from the amount of change per unit time in the inclination angle “θₓ”, and may be calculated from the amount of change per unit time in the inclination angle “θ_{y}”.

The description about FIG. 2 will be given again. The values of the acceleration in three-axis directions that are output from the correction unit 13, the inclination angles of three axes that are output from the inclination calculation unit 14, and the inclination angular velocities around three axes that are output from the inclination angular velocity calculation unit 15 are input to the selection unit 16. The selection unit 16 selects data to be output from the output units 18 to 20, the values of acceleration of three axes, the inclination angles of the three axes, and the inclination angular velocities around the three axes, based on information stored in the storage unit 17 to be described later.

The storage unit 17 is, for example, a random access memory (RAM), or the like. Information (hereinafter, referred to as a command) on the type of data that the selection unit 16 selects and outputs is stored in the storage unit 17. The command is transmitted from the controller 2, through the communication unit 21.

Further, the storage unit 17 is configured to read the stored command, from the controller 2. In other words, the controller 2 is capable of recognizing the type of the data that is output by the measurement apparatus 1, by accessing the storage unit 17 through the communication unit 21.

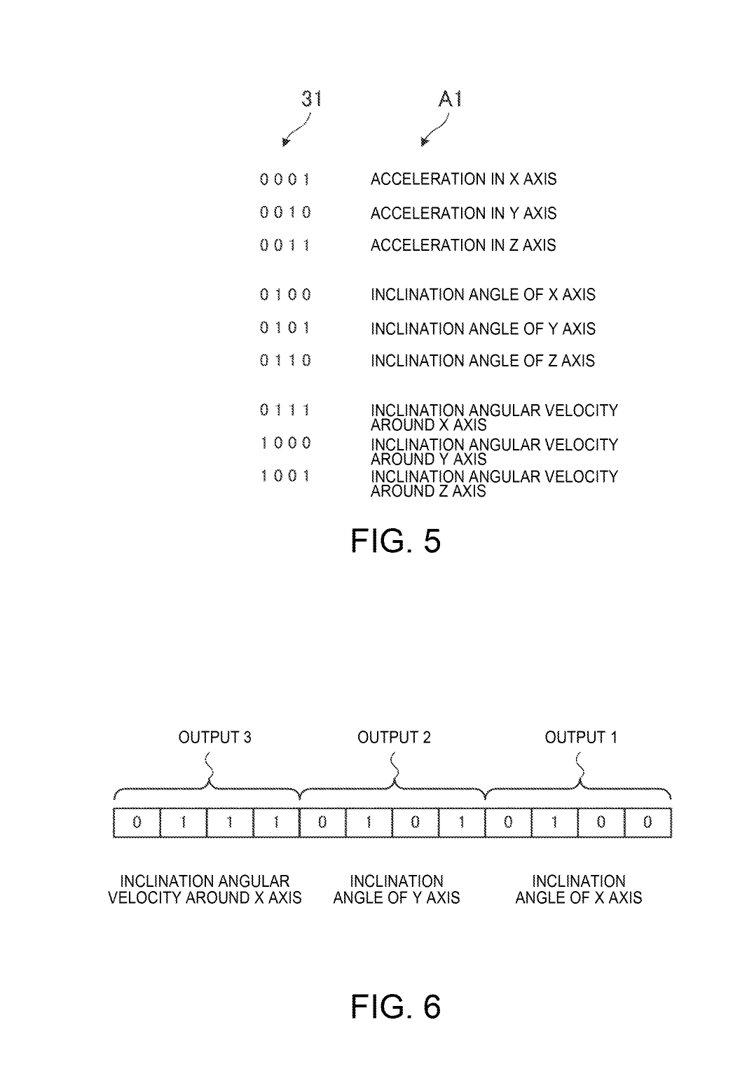

FIG. 5 is a diagram illustrating an example of commands. The command 31 illustrated in FIG. 5 represents a command that is stored in the storage unit 17. The command is represented by, for example, 4 bits of data. As illustrated in an arrow A1, the type of data that is selected and output by the selection unit 16 is associated with the command 31. For example, “the acceleration in the x axis” is associated with the command “0001”. Further, for example, “the inclination angle of the y axis” is associated with the command “0101”.

FIG. 6 is a diagram illustrating an example of commands that are stored in the storage unit 17. The storage unit 17 stores for example, 12 bits of information. A command to set the type of data to be output from the output unit 18 is stored in the 0-th bit to the third bit of the storage unit 17 (“Output 1” in FIG. 6). A command to set the type of data to be output from the output unit 19 is stored in the fourth bit to the seventh bit of the storage unit 17 (“Output 2” in FIG. 6). A command to set the type of data to be output from the output unit 20 is stored in the eighth bit to the 11-th bit of the storage unit 17 (“Output 3” in FIG. 6).

For example, the command “0100” of the inclination angle of the x axis illustrated in FIG. 5 is stored in “Output 1” of FIG. 6. The command “0101” of the inclination angle of the y axis illustrated in FIG. 5 is stored in “Output 2”. The command “0111” of the inclination angular velocity around the x axis illustrated in FIG. 5 is stored in “Output 3”.

Thus, when the command as illustrated in 6 is stored in the storage unit 17, the selection unit 16 outputs the inclination angle of the x axis output from the inclination calculation unit 14 to the output unit 18. Further, the selection unit 16 outputs the inclination angle of the y axis output from the inclination calculation unit 14 to the output unit 19. Further, the selection unit 16 outputs the inclination angular velocity around the x-axis output from the inclination angular velocity calculation unit 15 to the output unit 20. Thus, the selection unit 16 selects the data to be output from the output units 18 to 20, among values of the acceleration of the three axes, the inclination angles of three axes and the inclination angular velocities around the three axes, based on the command that is stored in the storage unit 17.

The description about FIG. 2 will be given again. The output units 18 to 20 output the data selected by the selection unit 16 to the controller 2 or an external device.

The communication unit 21 (which corresponds to the reception unit according to the invention) relays communication with the controller 2. For example, the communication unit 21 receives a command transmitted from the controller 2, and stores the command in the storage unit 17. Further, the communication unit 21 reads the command stored in the storage unit 17, and transmits the command to the controller 2, in response to an instruction from the controller 2.

The setting of the command by the controller 2 can be arbitrarily performed. For example, controller 2 can set the command in the measurement apparatus 1 while the measurement apparatus 1 is in operation.

In this way, the acceleration sensor 11 of the measurement apparatus 1 detects the values of the acceleration in three-axis directions. The inclination calculation unit 14 and the inclination angular velocity calculation unit 15 calculate the inclination angle and the inclination angular velocity as the predetermined physical quantities, based on the values of the acceleration in three-axis directions. Then, the measurement apparatus 1 is provided with the output units 18 to 20 that output the data, and the selection unit 16 selects the data to be output from the output units 18 to 30, from among the values of the acceleration in three-axis directions and the predetermined physical quantities. Thus, the measurement apparatus 1 is capable of suppressing the expansion of the apparatus scale (to three output units 18 to 20), and supporting different users or applications. In addition, the measurement apparatus 1 is capable of selecting and outputting the data required for the user, thereby suppressing the compression of the data rate.

In addition, the measurement apparatus 1 includes a communication unit 21 that receives a command from the controller 2, and the selection unit 16 selects the data to be output to the output units 18 to 20, depending on the command received by the communication unit 21. Thus, the user can easily switch the type of data to be output by the measurement apparatus 1, using the controller 2.

In addition, a command is read from the storage unit 17 by the controller 2. Thus, the user can easily check or recognize the type of the output data that is set in the measurement apparatus 1.

In addition, the measurement apparatus 1 is provided with three output units 18 to 20 so as to correspond to the three axes of the acceleration sensor 11. Thus, the controller 2 or the external device is able to achieve the physical quantities of the three axes at one time. For example, when the controller 2 or the external device requires the values of acceleration in three-axis directions from the measurement apparatus 1, the user may set a command in the three output units 18 to 20 so as to respectively output the acceleration in the x-axis direction, the acceleration in the y-axis direction, and the acceleration in the z-axis direction. In this case, the controller 2 or the external device is able to achieve all values of the acceleration in three-axis directions at one time. In contrast, for example, when the number of output units of the measurement apparatus 1 is 2, the controller 2 or the external device achieves the values of the acceleration in three-axis directions at two times, from each of two measurement apparatuses 1 at one time, the measurement apparatuses 1 being set in different directions so as to include three directions in which the detection axis directions are perpendicular to each other.

Incidentally, the acceleration sensor 11 detects the values of the acceleration in three-axis directions, but is not limited thereto. For example, the acceleration sensor 11 may detect the values of acceleration of two-axis directions. Then, the inclination calculation unit 14 calculates the inclination angles of the two orthogonal axes relative to the horizontal direction, and the inclination angular velocity calculation unit 15 may calculate the inclination angular velocity of the two axes. In this case, it is desirable to provide two output units.

Further, the calculation units (the inclination calculation unit 14 and the inclination angular velocity calculation unit 15) of the measurement apparatus 1 calculate the inclination angle and the inclination angular velocity as the predetermined physical quantity, but may calculate the velocity and displacement. For example, the calculation unit may calculate the velocity by integrating values of the acceleration output from the acceleration sensor 11, and calculate the displacement by integrating the calculated velocities. Then, the selection unit 16 may select the data to be output from the output units 18 to 20, from among the acceleration, the velocity, and the displacement. Further, the selection unit 16 may select the data to be output from the output units 18 to 20, from among the acceleration, the inclination angle, the inclination angular velocity, the velocity, and the displacement.

Further, the inclination calculation unit 14 and the inclination angular velocity calculation unit 15 may operate in response to the command stored in the storage unit 17. For example, when a command to output the values of the acceleration in three-axis directions is stored in the storage unit 17, the inclination calculation unit 14 and the inclination angular velocity calculation unit 15 do not need to calculate the inclination angle and the inclination angular velocity. Accordingly, in this case, the inclination calculation unit 14 and the inclination angular velocity calculation unit 15 may not operate. Further, the inclination calculation unit 14 and the inclination angular velocity calculation unit 15 may calculate only the inclination angle and the inclination angle of the axis corresponding to the command.

Further, in the above description, the inclination angles are set to “angles of the x, y, and z axes relative to the horizontal plane”, but are not limited thereto. For example, a reference plane is set as a plane intersecting the horizontal plane, and the angles between the reference plane and the x, y, and z axes may be set as inclination angles.

Further, the functions of the correction unit 13, the inclination calculation unit 14, the inclination angular velocity calculation unit 15, and the selection unit 16 may be implemented by, for example, a central processing unit (CPU), and may be implemented by a custom integrated circuit (IC) such as an application specific integrated circuit (ASIC).

Further, the data that is output from each of the output units 18 to 20 may be serial data, or parallel data.

### Second Embodiment

In a second embodiment, the measurement apparatus 1 is provided with a single output unit, and sequentially (one at a time) outputs the selected data in a predetermined order.

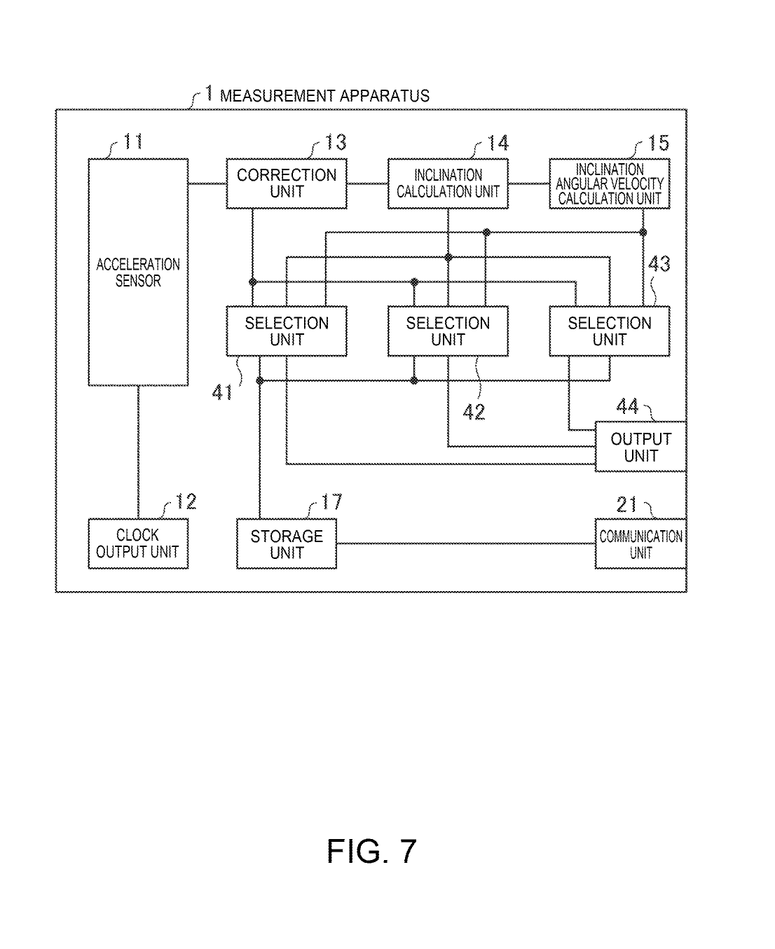

FIG. 7 is a diagram illustrating a block configuration example of the measurement apparatus 1 according to the second embodiment. The same components as in FIG. 2 are denoted by the same reference numerals in FIG. 7, and the description thereof will be omitted. As illustrated in FIG. 7, the measurement apparatus 1 includes selection units 41 to 43, and one output unit 44.

The selection units 41 to 43 select the data pieces that are output from the correction unit 13, the inclination calculation unit 14, and the inclination angular velocity calculation unit 15, based on the command that is stored in the storage unit 17. The selection units 41 to 43 sequentially output the selected data pieces, to the output unit 44, in a predetermined order. For example, the selection units 41 to 43 output the selected data pieces to the output unit 44 in an order of the selection unit 41, the selection unit 42, the selection unit 43, the selection unit 41, the selection unit 42, . . . .

The same command as in FIG. 6 is stored in the storage unit 17. In the second embodiment, “Output 1” illustrated in FIG. 6 is a command of the selection unit 41, “Output 2” is a command of the selection unit 42, and “Output 3” is a command of the selection unit 43.

For example, in the case of the command examples illustrated in FIG. 6, the selection unit 41 illustrated in FIG. 7 selects “the inclination angle of the x axis” that is output from the inclination calculation unit 14. The selection unit 42 selects “the inclination angle of the y axis” that is output from the inclination calculation unit 14. The selection unit 43 selects “the inclination angular velocity around the x axis” that is output from the inclination angle calculation unit 15. The selection units 41 to 43 output data pieces to the output unit 44, in order of “the inclination angle of the x axis”, “the inclination angle of the y axis”, “the inclination angular velocity around the x axis”, “the inclination angle of the x axis”, “the inclination angle of the y axis”, . . . . Thus, data pieces are output from the output unit 44, in order of “the inclination angle of the x axis”, “the inclination angle of the y axis”, “the inclination angular velocity around the x axis”, “the inclination angle of the x axis”, “the inclination angle of the y axis”, . . . .

Thus, the output unit 44 outputs the data pieces which are selected by the selection units 41 to 43, in a predetermined order. Thus, the measurement apparatus 1 is capable of suppressing the compression of the data rate of the data to be output, and supporting different users or applications.

For example, the measurement apparatus 1 is capable of suppressing the compression of the data rate, and supporting various users or applications by sequentially outputting three types of data required for the user, without sequentially outputting the total nine types of data.

Incidentally, the data pieces that are sequentially output may be serial data, or parallel data. For example, data pieces are output from the output unit 44, in order of “the inclination angle of the x axis”, “the inclination angle of the y axis”, “the inclination angular velocity around the x axis”, “the inclination angle of the x axis”, “the inclination angle of the y axis”, . . . , but the respective data pieces of “the inclination angle of the x axis”, “the inclination angle of the y axis”, “the inclination angular velocity around the x axis”, “the inclination angle of the x axis”, “the inclination angle of the y axis”, . . . may be serial data, or parallel data.

### Third Embodiment

In a third embodiment, the measurement apparatus 1 is provided with a decimation unit.

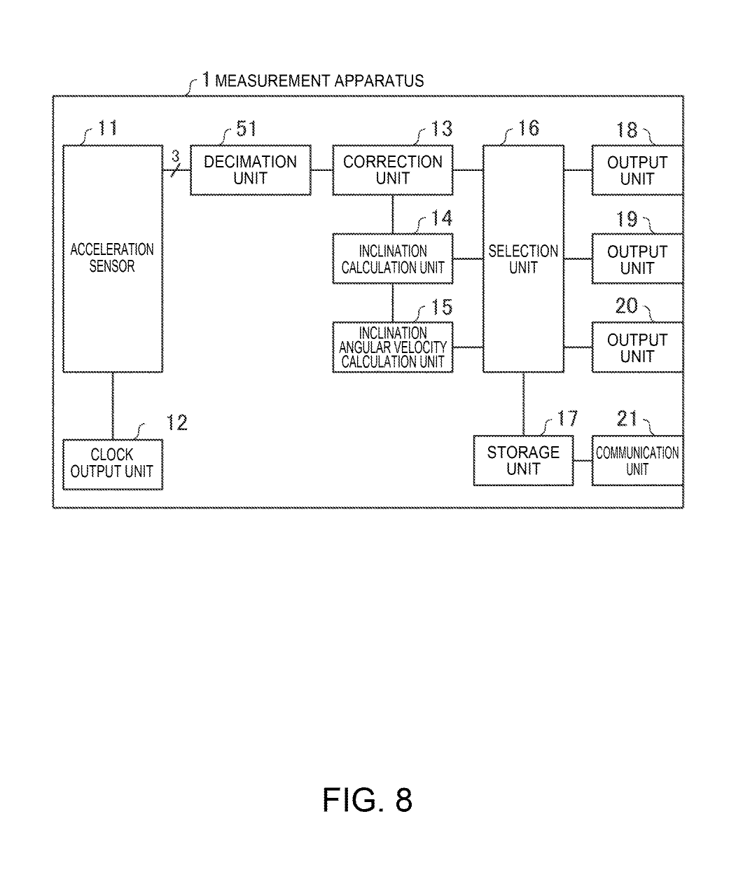

FIG. 8 is a diagram illustrating a block configuration example of a measurement apparatus 1 according to a third embodiment. The same components as in FIG. 2 are denoted by the same reference numerals in FIG. 8, and the description thereof will be omitted. As illustrated in FIG. 8, the measurement apparatus 1 includes a decimation unit 51 between the acceleration sensor 11 and the correction unit 13.

The decimation unit 51 performs the decimation on respective values of acceleration of three-axis directions which are output from the acceleration sensor 11. The decimation unit 51 includes, for example, a low-pass finite impulse response (FIR) filter that removes alias ing noise after down-sampling the acceleration, a down-sampler that down-samples the acceleration output from the acceleration sensor 11, and a calculation circuit that retains a decimation value of a maximum period of the available memory capacity, and outputs an average value of the retained decimation values in the required period range, if there is a long period down-sampling request that exceeds the memory capacity available for the decimation process, which is incorporated into the measurement apparatus.

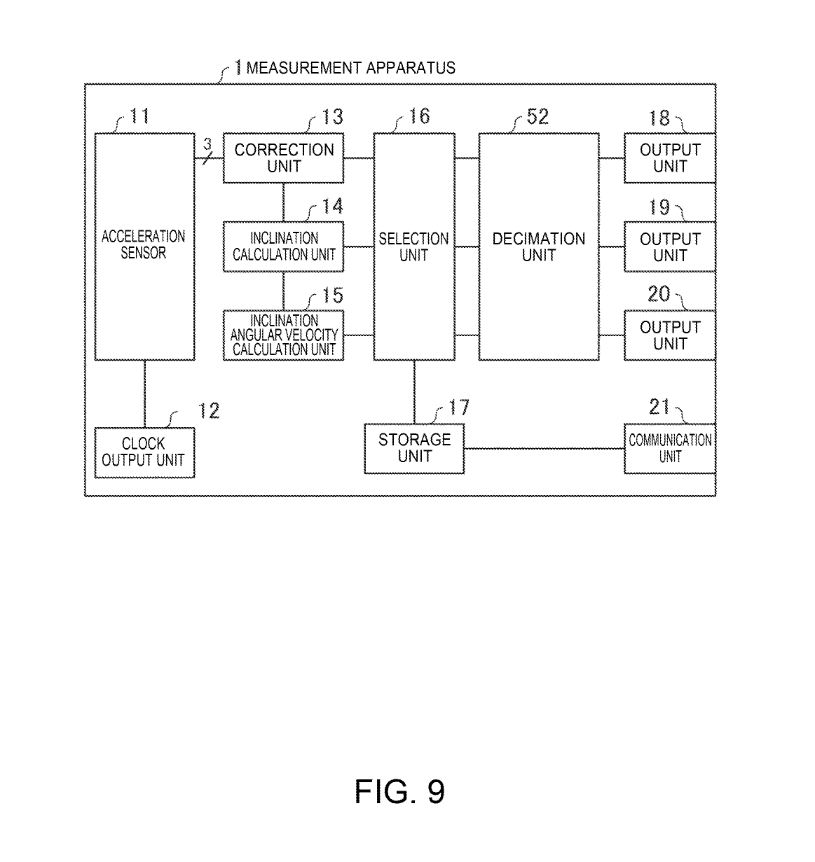

FIG. 9 is a diagram illustrating another block configuration example of the measurement apparatus 1. The same components as in FIG. 2 are denoted by the same reference numerals in FIG. 9, and the description thereof will be omitted. As illustrated in FIG. 9, the measurement apparatus 1 includes a decimation unit 52 between the selection unit 16 and the output units 18 to 20.

The decimation unit 52 performs the decimation on data which is output from the selection unit 16. Similar to the decimation unit 51 described in FIG. 8, the decimation unit 52 includes, for example, a low-pass FIR filter, a down-sampler that down-samples the data which is output from the selection unit 16, and a calculation circuit that retains a decimation value of a maximum period of the available memory capacity, and outputs an average value of the retained decimation values in the required period range, if there is a long period down-sampling request that exceeds the memory capacity available for the decimation process, which is incorporated into the measurement apparatus.

In the decimation process, it is automatically determined whether to output the decimation result depending on the data rate required from the controller 2, or to output the average value of the decimation values in the case of the data rate of the long period, and a process of averaging the decimation values is added, and signals are processed, if necessary for the requested long period data rate.

Thus, the measurement apparatus 1 includes the decimation unit 51 or the decimation unit 52 that decimates at least one of the acceleration output from the acceleration sensor 11 and the data selected by the selection unit 16. Thus, the measurement apparatus 1 is able to change the output rate of the data to be output.

Further, when the decimation unit 51 is provided in the subsequent stage of the acceleration sensor 11, it is possible to reduce the calculation amounts of the inclination calculation unit 14 and the inclination angular velocity calculation unit 15, compared to the case of providing the decimation unit 52 in the subsequent stage of the selection unit 16.

The invention has been described with reference to embodiments, but the functional configuration of the measurement apparatus is classified according to the main processing contents, in order to facilitate understanding of the configuration of the measurement apparatus. The invention is not limited depending on the classification method and names of components. The configuration of the measurement apparatus can be classified into a number of components, depending on the processing contents. Further, one component can be classified so as to execute more processes. The process of each component may be executed by a single piece of hardware, or may be executed by a plurality of pieces of hardware.

In addition, the technical scope of the invention is not limited to the scope described in the above embodiments. Adding various modifications and improvements to the embodiments described above will be apparent to those skilled in the art. For example, the decimation unit described in the third embodiment may be added to the second embodiment. Moreover, it is apparent from the appended claims that embodiments with such modifications or improvements belong to the scope of the invention. The invention can also be provided as a measurement method, a program of a measurement apparatus, and a storage medium storing the program.

The entire disclosure of Japanese Patent Application No. 2015-031760, filed Feb. 20, 2015 is expressly incorporated by reference herein.

What is claimed is:

1. A measurement apparatus comprising:
an acceleration sensor that detects values of acceleration in a plurality of directions;
a calculation unit that calculates a predetermined physical quantity based on the values of the acceleration in the plurality of directions;
an output unit that outputs data; and
a selection unit that selects data to be output from the output unit, from among the values of the acceleration in the plurality of directions and the predetermined physical quantity.

2. The measurement apparatus according to claim 1,
wherein the acceleration sensor detects values of acceleration in three-axis directions which are in a mutually perpendicular relationship.

3. The measurement apparatus according to claim 1,
wherein the calculation unit calculates an inclination angle in a predetermined direction, as the predetermined physical quantity.

4. The measurement apparatus according to claim 1,
wherein the calculation unit calculates an inclination angular velocity around each axis of axes in predetermined directions, as the predetermined physical quantity.

5. The measurement apparatus according to claim 1,
wherein the acceleration sensor detects values of acceleration in three-axis directions which are in a mutually perpendicular relationship,
wherein the calculation unit calculates inclination angles of three axes and inclination angular velocity around each axis of the three axes, based on the values of the acceleration in three-axis directions, as the predetermined physical quantities, and
wherein the selection unit selects three pieces of data to be output from the output unit, from among the values of the acceleration in three-axis directions, the inclination angles of three axes, and the inclination angular velocity around each axis of the three axes.

6. The measurement apparatus according to claim 1, further comprising:
a reception unit that receives a command from the outside,
wherein the selection unit selects data to be output from the output unit, in response to the command.

7. The measurement apparatus according to claim 6, further comprising:
a storage unit that stores the command so as to be readable from the outside.

8. The measurement apparatus according to claim 1,
wherein the output unit outputs the data selected by the selection unit, in a predetermined order.

9. The measurement apparatus according to claim 1, further comprising:
a decimation unit that performs a decimation process on at least one of the values of the acceleration in a plurality of directions and the data selected by the selection unit; and
a reception unit that receives a command from the outside,
wherein the decimation unit performs the decimation process, in response to the command.

10. The measurement apparatus according to claim 9,
wherein when the command is an instruction on an output at a cycle of a predetermined cycle or more corresponding to an available memory capacity, the decimation unit averages decimation values at the predetermined cycle, at a cycle that is instructed by the command.

11. A measurement method comprising:
detecting values of acceleration in a plurality of directions;
calculating a predetermined physical quantity, based on the values of the acceleration in the plurality of directions; and
selecting data to be output from an output unit, from among the values of the acceleration in the plurality of directions and the predetermined physical quantity.

12. A measurement system comprising:
a controller that outputs a command; and
a measurement apparatus including a reception unit that receives the command; an acceleration sensor that detects values of acceleration in a plurality of directions; a calculation unit that calculates a predetermined physical quantity based on the values of the acceleration in the plurality of directions; an output unit that outputs data; and a selection unit that selects data to be output from the output unit, from among the values of the acceleration in the plurality of directions and the predetermined physical quantity, in response to the command.
